(19) United States
(12) Patent Application Publication
(10) Pub. No.: US 2011/0025202 A1
(43) Pub. Date: Feb. 3, 2011

(54) ELECTROLUMINESCENCE ELEMENT, DISPLAY DEVICE, AND LIGHTING DEVICE

(75) Inventor: Yoshimasa Fujita, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/936,914

(22) PCT Filed: Jan. 20, 2009
(86) PCT No.: PCT/JP2009/050765

§ 371 Date: Oct. 8, 2010

(30) Foreign Application Priority Data
May 19, 2008 (JP) 2008-130952

(51) Int. Cl. H01J 1/62

(52) U.S. Cl. 313/506

(57) ABSTRACT

The present invention provides an organic electroluminescence element, a display device, and a lighting device, which have high efficiency and long life and are stable in the color purity. The present invention is an organic electroluminescence element comprising:
an anode;
a cathode; and
a plurality of emissive layers interposed between the anode and the cathode,
wherein
each of the plurality of emissive layers is a positive and negative charge-transport emissive layer comprising at least a hole transport material, an electron transport material, and a luminescent material,
the organic electroluminescence element further comprises an electron blocking layer and a hole blocking layer, the electron blocking layer comprising at least an electron blocking material and being provided between the anode and the plurality of emissive layers, the hole blocking layer comprising at least a hole blocking material and being provided between the cathode and the plurality of emissive layers,
an absolute value L_{EBM} and an absolute value L_{ETM} satisfy a formula of L_{EBM}<L_{ETM}, the absolute value L_{EBM} indicating a lowest unoccupied molecular orbital of the electron blocking material in the electron blocking layer, the absolute value L_{ETM} indicating a lowest unoccupied molecular orbital of the electron transport material in the positive and negative charge-transport emissive layer in contact with the electron blocking layer, and
an absolute value H_{HBM} and an absolute value H_{HTM} satisfy a formula of H_{HBM}>H_{HTM}, the absolute value H_{HBM} indicating a highest occupied molecular orbital of the hole blocking material in the hole blocking layer, the absolute value H_{HTM} indicating a highest occupied molecular orbital of the hole transport material in the positive and negative charge-transport emissive layer in contact with the hole blocking layer.

### TECHNICAL FIELD

The present invention relates to an organic electroluminescence element, a display device, and a lighting device. More specifically, the present invention relates to an organic electroluminescence element, a display device, and a lighting device, which have high efficiency and long life.

### BACKGROUND ART

Needs for flat panel displays (FPD) having characteristics of slim profile, low electrical power consumption, and light weight are now growing in the advance information society. Organic EL displays have received a great deal of attention attributed to its low-power operation and bright display. Especially, the recent development have significantly improved the luminous efficiency of organic EL devices comprising organic materials, and organic EL display devices equipped with such organic EL devices are now commercialized.

Methods for making full-color organic EL display device include: aligning organic electroluminescence elements (hereinafter, also referred to as “organic EL elements”) each emitting red, green, or blue light (for example, see Patent Document 1); and combining an organic EL element that emits white light and color filters each allowing light transmission in the wavelength range of red, green, or blue.

In addition, an organic EL element equipped with an emissive layer comprising a hole transport material and an electron transport material is disclosed (for example, see Patent documents 2 and 3).

### [Patent Document 1]

Japanese Kokai Publication No. Hei-10-3990

### [Patent Document 2]

Japanese Kokai Publication No. 2004-146221

[Patent documents 3]

Japanese Kokai Publication No. 2005-285708

### DISCLOSURE OF INVENTION

However, it has been difficult to have all the stacked emissive layers emit light efficiently in a conventional white organic EL element. Accordingly, the conventional white organic EL element has been inappropriate to be used in a display device due to its low luminous efficiency and short lifetime. Additionally, change in color purity caused by aging has needed to be improved.

The present invention is made in view of the above-mentioned state of the art, and an object thereof is to provide an organic electroluminescence element, a display device, and a lighting device, which have high efficiency and long life and are stable in the color purity.

The present inventors made various investigations on an organic electroluminescence element, a display device, and a lighting device, which have high efficiency and long life and is stable in its color purity. The present inventors focused their attentions on an organic EL device equipped with an emissive layer comprising a hole transport material and an electron transport material. Then, the present inventors have found out an organic EL element having the following configuration can control the balance between holes and electrons needed for light emission in all emissive layers, effectively suppress (preferably prevent) propagation of holes and electrons through luminescent material, and effectively suppress (preferably prevent) shift of a light-emitting area caused by aging through setting light-emitting areas in the emissive layers not to contact each other.

Namely, the organic EL element comprises: a plurality of emissive layers (positive and negative charge-transport emissive layers) including at least a hole transport material, an electron transport material, and a luminescent material; an electron-blocking layer provided between an anode and the plurality of emissive layers; and a hole-blocking layer provided between a cathode and the plurality of emissive layers. Here, the absolute value of lowest unoccupied molecular orbital of an electron-blocking material included in the electron-blocking layer is referred to as L_{EBM} and the absolute value of lowest unoccupied molecular orbital of the electron transport material included in the positive and negative charge-transport emissive layer in contact with the electron-blocking layer is referred to as L_{ETM}. Here, the absolute values of L_{EBM} and L_{ETM} satisfy a formula of L_{EBM}<L_{ETM}. Furthermore, the absolute value of highest occupied molecular orbital of a hole-blocking material included in the hole-blocking layer is referred to as H_{HBM} and the absolute value of highest occupied molecular orbital of the hole transport material included in the positive and negative charge-transport emissive layer in contact with the hole-blocking layer is referred to as H_{HTM}. Here, the absolute values of H_{HBM} and H_{HTM} satisfy a formula of H_{HBM}>H_{HTM}.

The present invention provides an organic electroluminescence element comprising:

an anode;

a cathode; and

a plurality of emissive layers interposed between the anode and the cathode,

wherein

each of the plurality of emissive layers is a positive and negative charge-transport emissive layer comprising at least a hole transport material, an electron transport material, and a luminescent material,

the organic electroluminescence element further comprises an electron blocking layer and a hole blocking layer, the electron blocking layer comprising at least an electron blocking material and being provided between the anode and the plurality of emissive layers, the hole blocking layer comprising at least a hole blocking material and being provided between the cathode and the plurality of emissive layers,

an absolute value L_{EBM} and an absolute value L_{ETM} satisfy a formula of L_{EBM}<L_{ETM}, the absolute value L_{EBM} indicating a lowest unoccupied molecular orbital of the electron blocking material in the electron blocking layer, the absolute value L_{ETM} indicating a lowest unoccupied molecular orbital of the electron transport material in the positive and negative charge-transport emissive layer in contact with the electron blocking layer, and

an absolute value H_{HBM} and an absolute value H_{HTM} satisfy a formula of H_{HBM}>H_{HTM}, the absolute value H_{HBM} indicating a highest occupied molecular orbital of the hole blocking material in the hole blocking layer, the absolute value H_{HTM} indicating a highest occupied molecular orbital of the hole transport material in the positive and negative charge-transport emissive layer in contact with the hole blocking layer.

Hereinafter, the present invention is specifically described.

An organic EL device of the present invention is an organic electroluminescence element comprising:

an anode;

a cathode; and

a plurality of emissive layers interposed between the anode and the cathode,

wherein

each of the plurality of emissive layers (at least two emissive layers mentioned above) is a positive and negative charge-transport emissive layer comprising at least a hole transport material, an electron transport material, and a luminescent material, and

the organic electroluminescence element further comprises an electron blocking layer and a hole blocking layer, the electron blocking layer comprising at least an electron blocking material and being provided between the anode and the plurality of emissive layers (at least two emissive layers mentioned above), the hole blocking layer comprising at least a hole blocking material and being provided between the cathode and the plurality of emissive layers (at least two emissive layers mentioned above).

This allows appropriate control of amounts of the hole transport material and the electron transport material in each positive and negative charge-transport emissive layer, and the balance between the holes injected via the anode and the electrons injected via the cathode may be maintained in each emissive layer. Consequently, the organic EL element is allowed to have high efficiency and long life.

In addition, it becomes possible to allow the holes and the electrons to propagate through a material other than the luminescent material. Then, degradation of the luminescent material caused by the holes and the electrons or by the action of the holes and the electrons with the excitons thereof. Consequently, the organic EL element is allowed to have long life.

Moreover, it is possible to set the light-emitting areas in emissive layers not to contact each other. An exemplary case is where the organic EL element has two emissive layers and has a structure in which an anode/a hole transport layer/an electron blocking layer/a first emissive layer/a second emissive layer/a hole blocking layer/an electron transport layer/a cathode are stacked in this order. In such a case, each emissive layer is a positive and negative charge-transport emissive layer capable of transporting holes and electrons. In addition, since the electron-blocking layer and the hole-blocking layer are provided, it is possible to store charge of the holes and the electrons: in the first emissive layer in the immediate vicinity of the interface with the electron blocking layer; and in the second emissive layer in the immediate vicinity of the interface with the hole blocking layer. Accordingly, it is possible to set the light-emitting areas in the first emissive layer and in the second emissive layer not to contact each other. Here, the light-emitting area in the first emissive layer is in the vicinity of the interface between the electron-blocking layer and the first emissive layer. Further, the light-emitting area in the second emissive layer is in the vicinity of the interface between the hole-blocking layer and the second emissive layer. Since it is possible to utilize the light emission in the interface in this manner, the light-emitting areas do not change even the carrier balance has changed due to aging. Thereby, the light emission that is stable in its color purity may be achieved.

Another exemplary case is where the organic EL element has three emissive layers and has a structure in which an anode/a hole transport layer/an electron blocking layer/a first emissive layer/a third emissive layer/a second emissive layer/a hole blocking layer/an electron transport layer/a cathode are stacked in this order. In such a case, each emissive layer is a positive and negative charge-transport emissive layer capable of transporting holes and electrons. In addition, since the electron-blocking layer and the hole-blocking layer are provided, it is possible to store charge of the holes and the electrons: in the first emissive layer in the immediate vicinity of the interface with the electron blocking layer; and in the second emissive layer in the immediate vicinity of the interface with the hole blocking layer. Accordingly, it is possible to set the light-emitting areas in the first emissive layer, in the second emissive layer, and in the third emissive layer not to contact one another. Here, the light-emitting area in the first emissive layer is in the vicinity of the interface between the electron-blocking layer and the first emissive layer. Further, the light-emitting area in the second emissive layer is in the vicinity of the interface between the hole-blocking layer and the second emissive layer. Moreover, the light-emitting area in the third emissive layer is in the middle of the layer. As a result, the light-emitting areas do not change even the carrier balance has changed due to aging. Thereby, the light emission that may be stable in its color purity may be achieved.

If two or more light-emitting areas are closely positioned, energy tends to shift from high-energy emission (short-wavelength emission) to low-energy emission (long-wavelength emission). In addition, if the emission areas get nearer to one another because of aging, the energy shift is increased and the color purity is changed.

The emissive layers (at least two emissive layers mentioned above) are positive and negative charge-transport emissive layers including at least a hole transport material, an electron transport material, and a luminescent material. This allows efficient and well-balanced transmission of holes and electrons to each emissive layer. In addition, it is possible to control the amounts of the hole transport material and of the electron transport material in each emissive layer, and therefore, it is possible to distribute the holes and the electrons at an intended ratio in each emissive layer. This allows control of the emission brightness of each emissive layer, leading to completion of a device having high luminous efficiency and long lifetime. Moreover, it is possible to have all emissive layers include the hole transport material, the electron transport material, and the luminescent material. This allows control of the ratio of the hole transport material and the electron transport material included in each emissive layer, leading to the control of the amounts of the holes and the electrons therein. Accordingly, even in the case where respective emissive layers comprise different luminescent materials varying in its hole transport capacity and electron transport capacity, it is possible to control the ratio of the holes and the electrons in respective emissive layers efficiently and in a well-balanced manner. Consequently, it becomes possible to complete a device having high luminous efficiency and long lifetime.

In order to make each positive and negative charge-transport emissive layer emit desired white light, an adjustment is needed with respect to the color purity and the brightness of the positive and negative charge-transport emissive layer. To achieve this, another adjustment is needed with respect to the ratio of the holes and the electrons in each positive and negative charge-transport emissive layer. Since each positive and negative charge-transport emissive layer in the organic EL element of the present invention has transportability of positive and negative charge, adjustment of the color purity and brightness thereof may be easily and efficiently carried out.

An exemplary case is where emissive layers comprise a positive and negative charge-transport red emissive layer (color purity: 0.67, 0.33), a positive and negative charge-transport green emissive layer (color purity: 0.21, 0.71), and a positive and negative charge-transport blue emissive layer (color purity: 0.14, 0.07). In order to obtain the color purity of white being (0.31, 0.31) in such a configuration, the brightness ratio needs to be the positive and negative charge-transport red emissive layer: the positive and negative charge-transport green emissive layer: the positive and negative charge-transport blue emissive layer=3:6:1.

The organic EL element of the present invention satisfies the formula 1. The difference of the LUMO level between the electron blocking material and the electron transport material in the emissive layer generates an energy barrier, and the energy barrier allows efficient storage of the charge in the interface between the electron blocking layer and the emissive layer. Consequently, the effect of the present invention may be more efficiently exerted.

The organic EL element of the present invention satisfies the formula 2. The difference of the HOMO level between the hole blocking material and the hole transport material in the emissive layer generates an energy barrier, and the energy barrier allows efficient storage of the charge in the interface between the hole blocking layer and the emissive layer. Consequently, the effect of the present invention may be more efficiently exerted.

The configuration of the organic EL element of the present invention is not especially limited as long as it essentially includes such components. The organic EL element may or may not include other components.

Preferable embodiments of the organic EL element of the present invention are mentioned in more detail below. The following embodiments may be employed in combination.

The hole transport materials in the positive and negative charge-transport emissive layers are preferably identical. This can avoid the energy barrier during transport of the holes in the positive and negative charge-transport emissive layers, and therefore, it becomes possible to allow the holes to propagate to the emissive layer more efficiently.

It is preferable that the concentration of the hole transport material is lower in the positive and negative charge-transport emissive layer positioned closer to the anode. This allows further efficient transport of the holes to the positive and negative charge-transport emissive layer positioned closer to the cathode.

The electron transport materials in the positive and negative charge-transport emissive layers are preferably identical. This can avoid the energy barrier during transport of the electrons in positive and negative charge-transport emissive layers, and therefore, it becomes possible to allow the electrons to propagate to the emissive layer more efficiently.

It is preferable that the concentration of the electron transport material is lower in the positive and negative charge-transport emissive layer positioned closer to the cathode. This allows further efficient transport of the electrons to the positive and negative charge-transport emissive layer positioned closer to the anode.

The present invention further provides a display device provided with the above-mentioned organic electroluminescence element and a lighting device provided with the above-mentioned organic electroluminescence element. The organic electroluminescence element allows completion of a display device and a lighting device which have high efficiency and long lifetime and is stable in the color purity.

### EFFECT OF THE INVENTION

According to the organic electroluminescence element, the display device, and the lighting device of the present invention, it is possible to achieve the improved efficiency, longer life, and stabilization of the color purity. More specifically, it is possible to: control the balance of the holes and the electrons, which make the organic EL element emit the light, in all the emissive layers; effectively suppressing the propagation of the holes and the electrons through the luminescent material; and effectively suppressing a shift of the light-emitting area in the emissive layers caused by aging through setting the light-emitting areas in the emissive layers not to contact each other.

### BEST MODES FOR CARRYING OUT THE INVENTION

The present invention is mentioned in more detail below with reference to Embodiments using drawings, but not limited to only these Embodiments.

### Embodiment 1

An organic EL element (organic EL device) of the present embodiment has at least two emissive layers between an anode and a cathode. Each emissive layer is a positive and negative charge-transport emissive layer, and each of the positive and negative charge-transport emissive layers comprises at least a hole transport material, an electron transport material, and a luminescent material. The organic EL element further has an electron blocking layer between the anode and one of the emissive layer and a hole blocking layer between the cathode and one of the emissive layer.

Exemplary structures of the organic EL element of the present embodiment are mentioned below, but the structure thereof is not limited to only these examples. For example, each layer in the exemplary structures is not limited to a monolayer and may be a multilayer. In addition, each exemplary structure may further comprise one or more layers. Here, it is to be noted that the emissive layer has a stack structure including at least two layers, preferably three layers.

(1) anode/hole injection layer/electron blocking layer/emissive layer/hole blocking layer/cathode

(2) anode/hole injection layer/hole transport layer/electron blocking layer/emissive layer/hole blocking layer/cathode

(3) anode/electron blocking layer/emissive layer/hole blocking layer/electron injection layer/cathode

(4) anode/electron blocking layer/emissive layer/hole blocking layer/electron transport layer/electron injection layer/cathode

(5) anode/hole injection layer/electron blocking layer/emissive layer/hole blocking layer/electron injection layer/cathode

(6) anode/hole injection layer/hole transport layer/electron blocking layer/emissive layer/hole blocking layer/electron injection layer/cathode

(7) anode/hole transport layer/electron blocking layer/emissive layer/hole blocking layer/electron transport layer/electron injection layer/cathode

(8) anode/hole injection layer/hole transport layer/electron blocking layer/emissive layer/hole blocking layer/electron transport layer/electron injection layer/cathode

A method for forming each layer mentioned above may be a conventionally-used method in the field of organic EL elements, but not limited to only the method.

Exemplary methods for forming organic layers (including emissive layer, hole transport layer, electron transport layer, hole injection layer, electron injection layer, hole blocking layer, electron blocking layer) include dry process such as vacuum deposition, and wet process such as a spin coating method, a doctor blade method, a dip-coating method, and a printing method, in the case where patterning of the organic layers is not needed. In contrast, in the case where patterning of the organic layers is needed (e.g. case where organic EL elements to be used in a multi-color display panel or a full-color display panel are manufactured), exemplary methods include dry process such as mask deposition (see Japanese kokai publication Hei-08-227276, for example) and a transfer method (see Japanese kokai publication Hei-10-208881, for example), and wet process such as an ink-jet method (see Japanese kokai publication Hei-10-12377, for example), a printing method, a discharge coating method, and a spray coating method. In the case of forming the organic layers by wet process, it is preferable to carry out the formation in an inert gas or in vacuo, in consideration of moisture absorption of the organic layers and alteration of the organic materials. In addition, the formed organic layers are preferably heated to be dried so that residual solvents are removed. The organic layers are preferably heated to be dried in an inert gas so that alteration of the organic materials is prevented. Further, the organic layers are preferably heated under reduced pressure so that the residual solvents are more effectively removed.

Exemplary methods for forming electrodes include dry process such as a deposition method, an EB method (electron beam codeposition), a MBE method (molecular beam epitaxy method), and a sputtering method, and wet process such as a spin coating method, a printing method, and an ink-jet method.

Hereinafter, the organic EL element of the present embodiment according to the present invention is described with reference to a drawing.

FIG. 1 is a schematic cross-sectional view illustrating a structure of an organic EL element of Embodiment 1.

The organic EL element of the present embodiment comprises a substrate 1 having an anode 2 such as ITO (Indium Tin Oxide), a hole injection layer 3, a hole transport layer 4, an electron blocking layer 5, emissive layers 6 (positive and negative charge-transport red emissive layer 61, positive and negative charge-transport green emissive layer 62, positive and negative charge-transport blue emissive layer 63), a hole blocking layer 7, an electron transport layer 8, an electron injection layer 9, and a cathode 10 sequentially stacked thereon.

The organic EL element illustrated in FIG. 1 may be manufactured by the following method, for example.

The substrate 1 of the present embodiment is not particularly limited as long as it has the insulating surface. Examples thereof include a substrate formed of an inorganic material such as glass and silica, a substrate formed of plastics such as polyethylene terephthalate, a substrate formed of ceramics such as alumina, a substrate obtainable by coating a metal substrate formed of aluminum, iron, and the like, with an insulant such as SiO₂ and organic insulating materials, and a substrate obtainable by insulating the surface of a metal substrate by anodic oxidation and the like.

A switching element such as a thin-film transistor (TFT) may be formed on the substrate 1. In the case of forming a polysilicon TFT by low temperature process, it is preferable to use a substrate that is not melt or deformed at a temperature not higher than 500° C. In addition, in the case of forming a polysilicon TFT by high temperature process, it is preferable to use a substrate that is not melt or deformed at a temperature not higher than 1000° C.

The anode 2 and the cathode 10 may be formed with use of a conventional electrode material. A metal electrode formed with use of a high work function metal (Au, Pt, Ni, etc.), or a transparent electrode formed with use of a transparent conductive material (ITO, IDIXO, SnO₂, etc.) may be used as the anode 2 through which holes are injected into organic layers. An electrode comprising: a high work function metal and a stable metal stacked therein (Ca/Al, Ce/Al, Cs/Al, Ba/Al, etc.); a low work function metal (Ca:Al alloy, Mg:Ag alloy, Li:Al alloy, etc.); or an insulating layer (thin film) and a metal electrode combined therein (LiF/Al, Lif/Ca/Al, BaF2/Ba/Al, etc.) may be used as the cathode 10 through which electrons are injected into organic layers. A method for producing the anode 2 and the cathode 10 may be dry process such as a deposition method, an EB method, a MBE method, and a sputtering method, and wet process such as a spin coating method, a printing method, and an ink-jet method. Here, the light emitted by the emissive layers 6 may be transmitted through the anode 2 to the side of the substrate 1 (bottom emission), or alternatively, through the cathode 10 to the opposite side of the substrate 1 (top emission). The thickness of the anode 2 is normally in a range from 10 to 1000 nm (preferably from 50 to 200 nm), though it depends on the material. The thickness of the cathode 10 is normally in a range from 1 to 50 nm (preferably 5 to 30 nm), though it depends on the material.

The hole injection layer 3 comprises a hole injection material having an excellent property of injecting holes to the electron blocking layer 5 or the hole transport layer 4, and has a function of enhancing the injection efficiency of holes from the anode 2 to the electron blocking layer 5 or the hole transport layer 4. The hole injection layer 3 may be formed by dry process such as direct deposition with use of at least one hole injection material. The hole injection layer 3 may comprise two or more hole injection materials. Such a hole injection layer 3 may comprise an additive (donor, acceptor, etc.). Further, the hole injection layer 3 may be formed by wet process with use of a coating liquid for forming a hole injection layer which comprises at least one hole injection material dissolved in a solvent. The coating liquid for forming a hole injection layer may comprise two or more hole injection materials. The coating liquid for forming a hole injection layer may further comprise a binding resin, a leveling agent, an additive (donor, acceptor, etc.), and the like. Examples of the binding resin include polycarbonate and polyester. The solvent is not particularly limited as long as it can dissolve or disperse the hole injection materials therein, and examples thereof include pure water, methanol, ethanol, THF (tetrahydrofuran), chloroform, xylene, and trimethylbenzene. The hole injection layer 3 may be formed by a laser transfer method. Here, the hole injection layer 3 may have a single-layer structure or a multi-layer structure. Namely, the hole injection layer 3 may have a stack structure of a plurality of hole injection layers that comprise hole injection materials different from one another. The thickness of the hole injection layer 3 is normally in a range from 1 to 1000 nm (preferably 10 to 300 nm), though it depends on the material.

As the hole injection material, conventionally known material for an organic EL element or for an organic photoconductor may be used. Examples thereof include: inorganic p-type semiconductor materials; low molecular materials including porphyrin compounds, aromatic tertiary amine compounds such as N,N′-bis-(3-methylphenyl)-N,N′-bis-(phenyl)-benzidine (TPD), N,N′-di(naphthalene-1-yl)-N,N′-diphenyl-benzidine (NPD), hydrazone compounds, quinacridone compounds, and styrylamine compounds; polymeric materials such as polyaniline (PANI), 3,4-polyethylenedioxythiophene/polystyrenesulfonate (PEDT/PSS), poly[triphenylamine derivatives] (Poly-TPD), and polyvinyl carbazole (PVCz); and polymeric material precursors such as a poly(p-phenylenevinylene) precursor (Pre-PPV), and a poly(p-naphthalenevinylene) precursor (Pre-PNV).

The hole transport layer 4 comprises a hole transport material having an excellent property of transporting holes and has a function of transporting holes from the anode 2 or the hole injection layer 3 to the electron blocking layer 5. The hole transport layer 4 maybe formed by dry process such as direct deposition with use of at least one hole transport material. The hole transport layer 4 may comprise two or more hole transport materials. Such a hole transport layer 4 may further comprise an additive (donor, acceptor, etc.). Moreover, the hole transport layer 4 may be formed by wet process with use of a coating liquid for forming a hole transport layer which comprises at least one hole transport material dissolved in a solvent. The coating liquid for forming a hole transport layer may comprise two or more hole transport materials. The coating liquid for forming a hole transport layer may further comprise a binding resin, a leveling agent, an additive (donor, acceptor, etc.), and the like. Examples of the binding resin include polycarbonate and polyester. The solvent is not particularly limited as long as it can dissolve or disperse the hole transport materials therein, and examples thereof include pure water, methanol, ethanol, THF, chloroform, xylene, and trimethylbenzene. The hole transport layer 4 maybe formed by a laser transfer method. Here, the hole transport layer 4 may have a single-layer structure or a multi-layer structure. Namely, the hole transport layer 4 may have a stack structure of a plurality of hole transport layers that comprise hole transport materials different from one another. The thickness of the hole transport layer 4 is normally in a range from 1 to 1000 nm (preferably 10 to 300 nm), though it depends on the material.

Any of the materials mentioned as the exemplary hole injection materials may be used as the hole transport material in the hole transport layer 4. However, the material preferably has a larger absolute value of the HOMO level compared to the hole injection material because holes are more efficiently injected and transferred to the emissive layers 6 and reduction in the voltage of elements or improvement in the luminous efficiency is achieved. Methods for measuring the HOMO level include UV photoelectron spectroscopy (UPS) and photoelectron yield spectroscopy (PYS) and the measurement may be carried out with use of a commercially-available ionization potential measuring device, such as AC-2 and AC-3 manufactured by RIKEN KEIKI Co., Ltd. and PYS-201 manufactured by Sumitomo Heavy Industries. Ltd.

The electron blocking layer 5 has a function of transporting holes from the anode 2, the hole injection layer 3, or the hole transport layer 4 to the emissive layers 6, and confining electrons injected from the side of the cathode 10 in the emissive layers 6. The electron blocking layer 5 may be formed by dry process such as direct deposition with use of at least one electron blocking material. The electron blocking layer 5 may comprise two or more electron blocking materials. Further, the electron blocking layer 5 may be formed by wet process with use of a coating liquid for forming an electron blocking layer which comprises at least one electron blocking material dissolved in a solvent. The coating liquid for forming an electron blocking layer may comprise two or more electron blocking materials. The coating liquid for forming an electron blocking layer may further comprise a binding resin, a leveling agent, an additive (donor, acceptor, etc.), and the like. Examples of the binding resin include polycarbonate and polyester. The solvent is not particularly limited as long as it can dissolve or disperse the electron blocking materials therein, and examples thereof include pure water, methanol, ethanol, THF, chloroform, xylene, and trimethylbenzene. The electron blocking layer 5 may be formed by a laser transfer method. Here, the electron blocking layer 5 may have a single-layer structure or a multi-layer structure.

The electron blocking material in the electron blocking layer 5 needs to have a smaller absolute value of the LUMO level compared to the hole injection material in the emissive layer 6 (positive and negative charge-transport red emissive layer 61) that is in contact with the electron blocking layer 5. This allows more efficient confinement of electrons in the emissive layers 6. The electron blocking material in the electron blocking layer 5 is selected in consideration of the confinement effect as the first priority. Here, the mobility of the holes of the electron blocking material in the electron blocking layer 5 is not regarded to be important. Accordingly, the electron blocking layer 5 normally needs to have a thickness of not more than 10 nm. When the electron blocking layer 5 is thicker than 10 nm, the driving voltage may be significantly increased. More specific examples of the electron blocking material in the electron blocking layer 5 include a compound of 4,4′-bis-[N,N′-(3-tolyl)amino]-3,3′-dimethylbiphenyl (HMTPD). The LUMO level is obtainable by a method comprising the steps of: measuring the absorption spectrum by ultraviolet visible spectroscopy and setting the absorption edge energy of that absorption spectrum as a bandgap; and subtracting the value of the bandgap from the value of the HOMO level obtained as mentioned above. The absorption spectrum may be measured with use of a commercially-available device, such as UV-1800 manufactured by Shimadzu Corporation and V-630 manufactured by JASCO Corporation.

In the emissive layers 6, recombination of injected holes and electrons allows emission of light at a wavelength peculiar to the contained luminescent material. The emissive layers 6 form a multi-layer structure comprising at least two positive and negative charge-transport emissive layers (here, the positive and negative charge-transport red emissive layer 61, the positive and negative charge-transport green emissive layer 62, and the positive and negative charge-transport blue emissive layer 63). Each positive and negative charge-transport blue emissive layer contains at least a hole transport material, an electron transport material, and a luminescent material. Each of such emissive layers 6 has functions of not only emitting light by the injected electrons and holes but also transporting the electrons and the holes.

The emissive layers 6 may be formed by dry process such as direct deposition with use of at least a hole transport material, an electron transport material, and a luminescent material. Each of the emissive layers 6 may comprise two or more hole transport materials, two or more electron transport materials, and two or more luminescent materials. Namely, the numbers of the hole transport material, the electron transport materials, and the luminescent materials in each positive and negative charge-transport emissive layer are not particularly limited, and two or more of these may be used in combination. Further, each of the emissive layers 6 may be formed by wet process with use of a coating liquid for forming an emissive layer which comprises at least a hole transport material, an electron transport material, and a luminescent material dissolved in a solvent. The coating liquid for forming an emissive layer may comprise two or more hole transport material, two or more electron transport materials, and two or more luminescent materials. Namely, the numbers of the hole transport material, the electron transport materials, and the luminescent materials in the coating liquid for forming an emissive layer are not particularly limited, and two or more of these may be used in combination. The coating liquid for forming an emissive layer may further comprise a binding resin, a leveling agent, an additive (donor, acceptor, etc.), and the like. Examples of the binding resin include polycarbonate and polyester. The solvent is not particularly limited as long as it can dissolve or disperse the hole transport materials, the electron transport materials, and luminescent materials therein. Examples thereof include pure water, methanol, ethanol, THF, chloroform, xylene, and trimethylbenzene. Each of the emissive layers 6 may be formed by a laser transfer method. The thickness of each of the emissive layers 6 is normally in a range from 1 to 1000 nm (preferably 10 to 300 nm), though it depends on the material. More specifically, the thickness of the positive and negative charge-transport red emissive layer 61 is normally in a range from 1 to 1000 nm (preferably 10 to 300 nm). The thickness of the positive and negative charge-transport green emissive layer 62 is normally in a range from 1 to 1000 nm (preferably 10 to 300 nm). The thickness of the positive and negative charge-transport blue emissive layer 63 is normally in a range from 1 to 1000 nm (preferably 10 to 300 nm).

Any of the material mentioned as the exemplary hole transport materials in the hole transport layer 4 may be used as the hole transport material in the emissive layers 6. In addition, the same material as a later-described electron transport material in the electron transport layer 8 maybe used as the electron transport material in the emissive layers 6.

The hole transport materials in respective positive and negative charge-transport emissive layers are preferably the same materials (substances) and the electron transport materials in respective positive and negative charge-transport emissive layers are preferably the same materials (substances).

In positive and negative charge-transport emissive layers, the concentration of the hole transport material is preferably lower in the layer positioned closer to the anode 2. Namely, in the case where the emissive layers 6 comprise the positive and negative charge-transport red emissive layer 61, the positive and negative charge-transport green emissive layer 62, and the positive and negative charge-transport blue emissive layer 63, the concentrations of the hole transport material preferably satisfy the relation of (the concentration in the positive and negative charge-transport red emissive layer 61)<(the concentration in the positive and negative charge-transport green emissive layer 62)<(the concentration in the positive and negative charge-transport blue emissive layer 63).

In contrast, in positive and negative charge-transport emissive layers, the concentration of the electron transport material is preferably lower in the layer positioned closer to the cathode 10. Namely, in the case where the emissive layers 6 comprise the positive and negative charge-transport red emissive layer 61, the positive and negative charge-transport green emissive layer 62, and the positive and negative charge-transport blue emissive layer 63, the concentrations of the electron transport material preferably satisfy the relation of (the concentration in the positive and negative charge-transport red emissive layer 61)>(the concentration in the positive and negative charge-transport green emissive layer 62)>(the concentration in the positive and negative charge-transport blue emissive layer 63). The concentration is determined by scaling the weight of each material.

The luminescent materials in the emissive layers 6 may be conventionally-known luminescent materials for organic EL elements, but the luminescent materials of the present invention is not particularly limited to these. Examples thereof include low-molecular luminescent materials, polymeric luminescent materials, and precursors of the polymeric luminescent materials. The specific examples of the low-molecular luminescent materials include fluorescent organic materials including aromatic dimethylidene compounds such as 4,4′-bis(2,2′-diphenylvinyl)-biphenyl (DPVBi), oxadiazole compounds such as 5-methyl-2-[2-[4-(5-methyl-2-benzooxazolyl)phenyl]vinyl]benzooxazole, triazole derivatives such as 3-(4-biphenylyl)-4-phenyl-5-t-butylphenyl-1,2,4-triazole (TAZ), styrylbenzene compounds such as 1,4-bis(2-methylstyryl)benzene, a thiopyrazinedioxide derivative, a benzoquinone derivative, a naphthoquinone derivative, an anthraquinone derivative, a diphenoquinone derivative and a fluorenone derivative, fluorescent organometallic compounds such as an azomethine zinc complex and a (8-hydroxyquinolinate) aluminum complex (AIq3). The specific examples of the polymeric luminescent materials include poly(2-decyloxy-1,4-phenylene) (DO-PPP), poly[2,5 -bis-[2-(N,N,N-triethylammonium)ethoxy]-1,4-phenyl-alto-1,4-phenylene]dibromide (PPP-NEt3+), poly[2-(2′-ethylhexyloxy)-5-methoxy-1,4-phenylenevinylene] (MEH-PPV), poly[5-methoxy-(2-propanoxysulfonide)-1,4-phenylenevinylene] (MPS-PPV), poly[2,5-bis-(hexyloxy)-1,4-phenylene-(1-cyanovinylene)] (CN-PPV), poly(9,9-dioctylfluorene) (PDAF) and polyspiro. The specific examples of the precursors of the polymeric luminescent materials include a PPV precursor, a PNV precursor and a PPP precursor.

Here, the luminescent material in the positive and negative charge-transport red emissive layer 61 has its emission peak in a wavelength range from 600 to 700 nm in the form of solid or solution. The luminescent material in the positive and negative charge-transport green emissive layer 62 has its emission peak in a wavelength range from 500 to 600 nm in the form of solid or solution. The luminescent material in the positive and negative charge-transport blue emissive layer 63 has its emission peak in a wavelength range from 400 to 500 nm in the form of solid or solution.

The hole blocking layer 7 has a function of transporting electrons from the cathode 10, the electron injection layer 9 or the electron transport layer 8 to the emissive layers 6, and confining holes injected from the side of the anode 2 in the emissive layers 6. The hole blocking layer 7 may be formed by dry process such as direct deposition with use of at least one hole blocking material. The hole blocking layer 7 may comprise two or more hole blocking materials. Further, the hole blocking layer 7 may be formed by wet process with use of a coating liquid for forming a hole blocking layer which comprises at least one hole blocking material dissolved in a solvent. The coating liquid for forming a hole blocking layer may comprise two or more hole blocking materials. The coating liquid for forming a hole blocking layer may further comprise a binding resin, a leveling agent, an additive (donor, acceptor, etc.), and the like. Examples of the binding resin include polycarbonate and polyester. The solvent is not particularly limited as long as it can dissolve or disperse the hole blocking materials therein, and examples thereof include pure water, methanol, ethanol, THF, chloroform, xylene, and trimethylbenzene. The hole blocking layer 7 may be formed by a laser transfer method. Here, the hole blocking layer 7 may have a single-layer structure or a multi-layer structure.

The hole blocking material in the hole blocking layer 7 needs to have a larger absolute value of the HOMO level compared to the electron transport material in the emissive layer 6 (positive and negative charge-transport blue emissive layer 63) that is in contact with the hole blocking layer 7. This allows more efficient confinement of holes in the emissive layers 6. The hole blocking material in the hole blocking layer 7 is selected in consideration of the confinement effect as the first priority. Here, the mobility of the electrons of the hole blocking material in the hole blocking layer 7 is not regarded to be important. Accordingly, the hole blocking layer 7 normally needs to have a thickness of not more than 10 nm. When the hole blocking layer 7 is thicker than 10 nm, the driving voltage may be significantly increased. More specific examples of the hole blocking material in the hole blocking layer 7 include a compound such as 2,9-dimethyl-4,7-diphenyl-1,10-phenanthroline (BCP).

The electron transport layer 8 comprises an electron transport material having an excellent property of transporting electrons and has a function of transporting electrons from the cathode 10 or the electron injection layer 9 to the hole blocking layer 7. The electron transport layer 8 may comprise only an electron transport material mentioned below, or alternatively, the electron transport layer 8 may further comprise an additive (donor, acceptor, etc.). In the electron transport layer 8, the electron transport material mentioned below may be dispersed in a polymeric material (binding resin) or in an inorganic material. Further, two or more of the electron transport materials mentioned below may be used in combination to form the electron transport layer 8. Here, the electron transport layer 8 may have a single-layer structure or a multi-layer structure. Namely, the electron transport layer 8 may have a stack structure of a plurality of electron transport layers that comprise electron transport materials different from one another. The thickness of the electron transport layer 8 is normally in a range from 1 to 1000 nm (preferably 10 to 300 nm), though it depends on the material.

Conventionally-known electron transport materials for organic LEDs may be used here. Specific examples thereof are mentioned below, but the present invention is not limited by these.

Examples of the electron transport material include an inorganic material of a n-type semiconductor, low molecular materials, and polymeric materials. Specific examples of the low molecular materials include an oxadiazole derivative, a triazole derivative, a thiopyrazine dioxide derivative, a benzoquinone derivative, a naphthoquinone derivative, an anthraquinone derivative, a diphenoquinone derivative, a fluorenone derivative and a metal complex such as 8-hydroxyquinoline aluminum. Specific examples of the polymeric material include poly(oxadiazole) (Poly-OXZ), and a polystyrene derivative (PSS).

The electron injection layer 9 comprises an electron injection material having an excellent property of injecting electrons to the hole blocking layer 7 or the hole transport layer 8, and has a function of enhancing the injection efficiency of electrons from the cathode 10 to the hole blocking layer 7 or the hole transport layer 8. The electron injection layer 9 may be formed by dry process such as direct deposition with use of at least one electron injection material. The electron injection layer 9 may comprise two or more electron injection materials. Such an electron injection layer 9 may comprise an additive (donor, acceptor, etc.). Further, the electron injection layer 9 may be formed by wet process with use of a coating liquid for forming an electron injection layer which comprises at least one electron injection material dissolved in a solvent. The coating liquid for forming an electron injection layer may comprise two or more electron injection materials. The coating liquid for forming an electron injection layer may further comprise a binding resin, a leveling agent, an additive (donor, acceptor, etc.), and the like. Examples of the binding resin include polycarbonate and polyester. The solvent is not particularly limited as long as it can dissolve or disperse the electron injection materials therein, and examples thereof include pure water, methanol, ethanol, THF, chloroform, xylene, and trimethylbenzene. The electron injection layer 9 may be formed by a laser transfer method. Here, the electron injection layer 9 may have a single-layer structure or a multi-layer structure. Namely, the electron injection layer 9 may have a stack structure of a plurality of electron injection layers that comprise electron injection materials different from one another. The thickness of the electron injection layer 9 is normally in a range from 1 to 1000 nm (preferably 10 to 300 nm), though it depends on the material.

Preferable examples of the electron injection material include fluorides such as lithium fluoride (LiF) and barium fluoride (BaF₂), and oxides such as lithium oxide (Li₂O). From the standpoint of efficiently conducting injection and transport of electrons, it is preferable to use a material having a higher energy level of the lowest unoccupied molecular orbital (LUMO) compared to the electron injection transport material to be used for forming the electron transport layer 9, as a material for forming the electron injection layer 9. Additionally, it is preferable to use a material having a higher electron mobility compared to the electron injection transport material to be used for forming the electron injection layer 9, as a material for forming the electron transport layer 8.

In the present embodiment, a sealing substrate is used to seal the organic EL element. However, a sealing film may be used instead of the sealing substrate. A material conventionally used for sealing may be used to form a sealing film or a sealing substrate. In addition, sealing may be conducted by a known method. Examples thereof include: a method of sealing an inert gas such as nitrogen gas and argon gas by glass, metals, and the like; and a method of further mixing a moisture absorbent such as barium oxide in the inert gas. Further, a sealing film may be formed by directly spin-coating or pasting a resin on the cathode 10. In this manner, it is possible to prevent oxygen and moisture from being contained in the organic EL element from outside by sealing the organic layers and the electrodes. Consequently, it is possible to lengthen the life of the organic EL element.

According to the organic EL element having the above structure, the positive and negative charge-transport red emissive layer 61 (red emissive layer capable of transporting positive and negative charges), the positive and negative charge-transport green emissive layer 62 (green emissive layer capable of transporting positive and negative charges), and the positive and negative charge-transport blue emissive layer 63 (blue emissive layer capable of transporting positive and negative charges) are stacked sequentially from the side of the anode 2. This allows emission of red, green, and blue lights. In particular, by using the organic EL element and a color filter in combination, it is possible to produce a display device capable of conducting full-color display excellent in color reproducibility.

In a case where a full-color display device comprises a plurality of organic EL elements and three color filters in combination, the first, second, and third color filters transmitting light in wavelength ranges of blue, green, and red, respectively, is provided on the emitting side of each of the plurality of organic EL elements. This makes emission of the organic EL on the emitting side of each organic EL element pass through each color filter. This allows well-balanced light in wavelength ranges of blue, green, and red, leading to a full-color display excellent in reproducibility.

A lighting device such as a surface light source may be produced with use of the organic EL element of the present embodiment.

In the above-described embodiment, there has been described an organic EL element comprising: the anode 2 provided on the substrate 1; and the organic layers and the cathode 10 which are stacked on the anode 2. However, the present invention is also applicable to an organic EL element comprising: a cathode provided on the substrate 1; and the organic layers and an anode which are stacked on the cathode in this order. Even in such a configuration, both top emission and bottom emission can be carried out by appropriately selecting materials and the thickness of a cathode and an anode.

### EXAMPLE 1

First, an electrode (anode) 2 was formed on a glass substrate (substrate 1). More specifically, a substrate with an electrode was prepared and cleaned, which was a glass substrate (30×30 mm) preliminary having an ITO (indium oxide-tin oxide) electrode formed on its surface. As cleaning of the substrate with an electrode, the substrate may be subjected to ultrasonic cleaning with use of acetone and IPA (isopropyl alcohol) for 10 minutes followed by UV-ozone cleaning for 30 minutes.

Next, a layer of copper phthalocyanine (CuPc) was formed by vacuum deposition on the surface of the electrode 2 as the hole injection layer 3 (thickness of 30 nm).

Then, the hole transport layer 4 (thickness of 20 nm) was formed on the hole injection layer 3 with use of 4′-bis[N-(1-naphthyl)-N-phenyl-amino]biphenyl) (α-NPD).

On the hole transport layer 4, the electron blocking layer (thickness of 10 nm) was formed with use of 4,4′-bis-[N,N′-(3-tolyl)amino]-3,3′-dimethylbiphenyl (HMTPD). Here, the material had a LUMO value of 2.3 eV.

On the electron blocking layer 5, the positive and negative charge-transport red emissive layer 61 (thickness of 20 nm, for example) was formed. The positive and negative charge-transport red emissive layer 61 was formed by co-depositing α-NPD (hole transport material), 3-phenyl-4(1-naphthyl)-5-phenyl-1,2,4-triazole(TAZ) (electron transport material), and bis(2-(2′-benzo[4,5-α]thienyl)pyridinato-N, C3′)ilidium(ace tylacetonate) (btp2Ir(acac)) (red-emissive dopant). Here, the α-NPD had a deposition rate of 0.6 Å/sec (Å=0.1 nm). The TAZ had a deposition rate of 1.4 Å/sec. The btp2Ir(acac) had a deposition rate of 0.15 Å/sec.

On the positive and negative charge-transport red emissive layer 61, the positive and negative charge-transport green emissive layer 62 (thickness of 20 nm, for example) was formed. The positive and negative charge-transport green emissive layer 62 was formed by co-depositing α-NPD (hole transport material), TAZ (electron transport material), and tris(2-phenylpyridinato-N,C2′)iridium (III) (Ir(ppy)3) (green-emissive dopant). Here, the α-NPD had a deposition rate of 1.0 Å/sec. The TAZ had a deposition rate of 1.0 Å/sec. The Ir(ppy)3 had a deposition rate of 0.1 Å/sec.

On the positive and negative charge-transport green emissive layer 62, the positive and negative charge-transport blue emissive layer 63 (thickness of 10 nm, for example) was formed. The positive and negative charge-transport blue emissive layer 63 was formed by co-depositing α-NPD (hole transport material), TAZ (electron transport material), and 2-(4′-t-butylphenyl)-5-(4″-biphenylyl)-1,3,4-oxadiazole (t-Bu PBD) (blue-emissive dopant). Here, the α-NPD had a deposition rate of 1.5 Å/sec. The TAZ had a deposition rate of 0.5 Å/sec. The t-Bu PBD had a deposition rate of 0.2 Å/se. In this manner, the emissive layers 6 were formed. Here, the electron transport material (TAZ) had a LUMO value of 2.6 eV. The hole transport material (α-NPD) had a HOMO value of 5.5 eV.

Next, on the emissive layers 6, the hole blocking layer (thickness of 10 nm) was formed with use of 2,9-dimethyl-4,7-diphenyl-1,10-phenanthyoline (BCP). The material had a HOMO value of 6.7 eV.

On the hole blocking layer 7, the electron transport layer (thickness of 30 nm) was formed with use of tris(8-hydroxyquinoline)aluminum (Alq3).

On the electron transport layer 8, the electron injection layer 9 (thickness of 1 nm) was formed with use of lithium fluoride (LiF).

Then, an electrode (cathode) 10 was formed, for example, by the following method. First, the substrate was fixed to a chamber for metal deposition. Then, aluminum was deposited (to the thickness of 300 nm, for example) on the surface of the electron injection layer 9 by vacuum deposition. In this manner, the cathode 10 was formed.

Finally, the glass substrate (substrate 1) and a sealing glass (not illustrated) were bonded by a UV-curing resin to complete an organic EL element of the present Example.

Here, the electron blocking material in the electron blocking layer 5 and the electron transport material in the emissive layer 6 (positive and negative charge-transport red emissive layer 61) satisfied L_{EBM} (2.3 eV)<L_{ETM} (2.6 eV), i.e., the formula 1.

In addition, the hole blocking material in the hole blocking layer 7 and the hole transport material in the emissive layer 6 (positive and negative charge-transport blue emissive layer 63) satisfied H_{HBM} (6.7 eV)>H_{HTM} (5.5 eV), i.e., the formula 2.

Moreover, the same hole transport materials, i.e., α-NPD, were contained in the positive and negative charge-transport red emissive layer 61, the positive and negative charge-transport green emissive layer 62, and the positive and negative charge-transport blue emissive layer 63. The same electron transport materials, i.e., TAZ, were contained in the positive and negative charge-transport red emissive layer 61, the positive and negative charge-transport green emissive layer 62, and the positive and negative charge-transport blue emissive layer 63.

The concentration of the hole transport material (α-NPD) contained in the positive and negative charge-transport red emissive layer 61, the positive and negative charge-transport green emissive layer 62, and the positive and negative charge-transport blue emissive layer 63 was lower in the layer positioned closer to the anode 2. The concentration of the electron transport material (TAZ) contained in the positive and negative charge-transport red emissive layer 61, the positive and negative charge-transport green emissive layer 62, and the positive and negative charge-transport blue emissive layer 63 was lower in the layer positioned closer to the cathode 10.

Thus-produced organic EL element emitted 1000 cd/m² of white light with an application of 6 V charge. Measurement clarified that the brightness half-life thereof was 1000 h. The change in the color purity during that period was not exceeding 0.03 with respect to both x and y. The luminous efficiency was 10 lm/W.

### Example 2

An organic EL element of Example 2 had the same configuration as the organic EL element of Example 1. However, in Example 2, the deposition rate in producing the positive and negative charge-transport red emissive layer 61 was changed. Namely, the α-NPD had a deposition rate of 0.6 Å/sec. The TAZ had a deposition rate of 1.4 Å/sec. The btp21r(acac) had a deposition rate of 0.15 Å/se. In addition, the deposition rate in producing the positive and negative charge-transport blue emissive layer 63 was changed. Namely, the α-NPD had a deposition rate of 0.5 Å/sec. The TAZ had a deposition rate of 1.5 Å/sec. The t-Bu PBD had a deposition rate of 0.2 Å/se.

Accordingly, the concentration of the hole transport material (α-NPD) contained in the positive and negative charge-transport red emissive layer 61, the positive and negative charge-transport green emissive layer 62, and the positive and negative charge-transport blue emissive layer 63 was not lower in the layer positioned closer to the anode 2. The concentration of the electron transport material (TAZ) contained in the positive and negative charge-transport red emissive layer 61, the positive and negative charge-transport green emissive layer 62, and the positive and negative charge-transport blue emissive layer 63 was not lower in the layer positioned closer to the cathode 10.

Thus-produced organic EL element emitted 9000 cd/m² of white light with an application of 6 V charge. Measurement clarified that the brightness half-life thereof was 600 h. The change in the color purity during that period was 0.1 with respect to both x and y. The luminous efficiency was 15 lm/W.

### Comparative Example 1

An organic EL element of Comparative Example 1 had the same configuration as the organic EL element of Example 1. However, in the comparative Example 1, the electron blocking layer 5 (thickness of 10 nm) was formed with use of Ir(ppy)3. Here, the material had a LUMO value of 2.9 eV.

The relation between the electron blocking material in the electron blocking layer 5 and the electron transport material in the emissive layer 6 (positive and negative charge-transport red emissive layer 61) is L_{EBM} (2.9 eV)>L_{ETM} (2.6 eV), i.e., the formula 1 is not satisfied.

Thus-produced organic EL element emitted 5000 cd/m² of white light with an application of 6 V charge. Measurement clarified that the brightness half-life thereof was 300 h that was shorter than the values obtained in Examples 1 and 2. The change in the color purity during that period was 0.08 with respect to both x and y, which was larger than the value obtained in Example 1. The luminous efficiency was 7 lm/W.

### Comparative Example 2

An organic EL element of Comparative Example 2 had the same configuration as the organic EL element of Example 1. However, in Comparative Example 2, the hole blocking layer 7 (thickness of 10 nm) was formed with use of nickel phthalocyanine. Here, the material had a HOMO value of 4.8 eV.

The relation between the hole blocking material in the hole blocking layer 7 and the hole transport material in the emissive layer 6 (positive and negative charge-transport blue emissive layer 63) is H_{HBM} (4.8 eV)<H_{HTM} (5.5 eV), i.e., the formula 2 is not satisfied.

Thus-produced organic EL element emitted 1000 cd/m² of white light with an application of 6 V charge. Measurement clarified that the brightness half-life thereof was 300 h that was shorter than the values obtained in Examples 1 and 2. The change in the color purity during that period was 0.2 with respect to both x and y, which was significantly larger than the values obtained in Examples 1 and 2. The luminous efficiency was 6 lm/W.

The present application claims priority to Patent Application No. 2008-130952 filed in Japan on May 19, 2008 under the Paris Convention and provisions of national law in a designated State, the entire contents of which are hereby incorporated by reference.

### BRIEF DESCRIPTION OF THE DRAWINGS

FIG. 1 is a schematic cross-sectional view illustrating the configuration of the organic EL element of Embodiment 1.

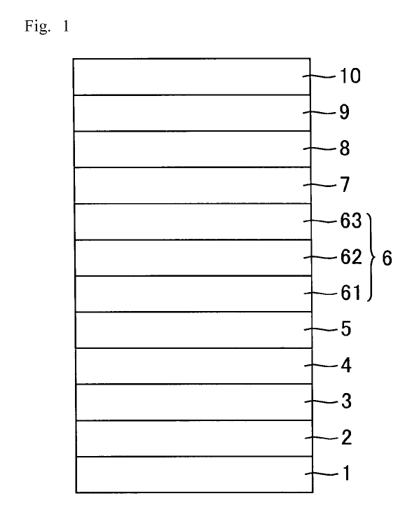

### EXPLANATION OF NUMERALS AND SYMBOLS

1: Substrate
2: Anode
3: Hole injection layer
4: Hole transport layer
5: Electron blocking layer
6: Emissive layer
61: Positive and negative charge-transport red emissive layer
62: Positive and negative charge-transport green emissive layer
63: Positive and negative charge-transport blue emissive layer
7: Hole blocking layer
8: Electron transport layer
9: Electron injection layer
10: Cathode

1. An organic electroluminescence element comprising:
an anode;
a cathode; and
a plurality of emissive layers interposed between the anode and the cathode,
wherein
each of the plurality of emissive layers is a positive and negative charge-transport emissive layer comprising at least a hole transport material, an electron transport material, and a luminescent material,
the organic electroluminescence element further comprises an electron blocking layer and a hole blocking layer, the electron blocking layer comprising at least an electron blocking material and being provided between the anode and the plurality of emissive layers, the hole blocking layer comprising at least a hole blocking material and being provided between the cathode and the plurality of emissive layers,
an absolute value L_{EBM} and an absolute value L_{ETM} satisfy a formula of H_{HBM}>H_{HTM}, the absolute value L_{EBM} indicating a lowest unoccupied molecular orbital of the electron blocking material in the electron blocking layer, the absolute value L_{ETM} indicating a lowest unoccupied molecular orbital of the electron transport material in the positive and negative charge-transport emissive layer in contact with the electron blocking layer, and
an absolute value H_{HBM} and an absolute value H_{HTM} satisfy a formula of H_{HBM}>H_{HTM}, the absolute value H_{HBM} indicating a highest occupied molecular orbital of the hole blocking material in the hole blocking layer, the absolute value H_{HTM} indicating a highest occupied molecular orbital of the hole transport material in the positive and negative charge-transport emissive layer in contact with the hole blocking layer.

2. The organic electroluminescence element according to claim 1,
wherein the hole transport materials in the positive and negative charge-transport emissive layers are identical.

3. The organic electroluminescence element according to claim 2,
wherein concentration of the hole transport material is lower in the positive and negative charge-transport emissive layer positioned closer to the anode.

4. The organic electroluminescence element according to claim 1,
wherein the electron transport materials in the positive and negative charge-transport emissive layers are identical.

5. The organic electroluminescence element according to claim 4,
wherein concentration of the electron transport material is lower in the positive and negative charge-transport emissive layer positioned closer to the cathode.

6. A display device comprising
the organic electroluminescence element according to claim 1.

7. A lighting device comprising
the organic electroluminescence element according to claim 1.
